(19) United States
(12) Patent Application Publication
(10) Pub. No.: US 2004/0073602 A1
(43) Pub. Date: Apr. 15, 2004

(54) Program distribution system

(75) Inventor: Katsutoshi Higuchi, Atsugi-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Motor Co., Ltd., Yokohama (JP)

(21) Appl. No.: 10/628,382

(22) Filed: Jul. 29, 2003

(30) Foreign Application Priority Data
Aug. 22, 2002 (JP) JP 2002-241687

(51) Int. Cl. G06F 15/16

(52) U.S. Cl. 709/201

(57) ABSTRACT

A program distribution system for distributing a program to a client is provided with a program distributing device and a client terminal device utilized by the client. The program distributing device includes a program subdividing section for subdividing the program into a plurality of program blocks each having a predetermined size, and a program distributing-section configured to store the program blocks, authenticate the client and distribute the program blocks to a client terminal device. The client terminal device includes a program block storing portion, a restoration schedule setting portion, and a program storing portion. The restoration schedule setting portion is configured to set a scheduled time for restoration of the program from the program blocks. The distribution of the program blocks from the program distribution device to the client terminal device is executed in a time-divided manner.

### BACKGROUND OF THE INVENTION

1. Field of the Invention

The present invention relates to a program distribution technology. More specifically, the present invention relates to a technology for distributing a large program (e.g., CAD) to a plurality of clients without impeding the communications taking place on a network such that the plurality of clients can open the program simultaneously after a scheduled releasing date.

2. Background Information

Several proposals have been made regarding methods for distributing a program from a server to a client having a specified contractual relationship through the internet or other network. In such proposed methods, in order to obtain information that has been stored in a server, a client provides a keyword to the server for enabling the server to recognize the client and designate a genre or title of information required. For example, Japanese Laid-Open Patent Publication No. 2002-41394 describes a technology in which an information provider supplies information content or revision information for revising previously supplied information to an information distributor through the internet. The distributor has a receiving server, a distribution server, and a database server, each of which is connected to the internet through a firewall. Meanwhile, the client uses a client terminal device to send client-specific identification information and a communication request to the distributor through the internet. If the identification information sent from the client matches the identification information already registered with the distributor, the distributor permits communication with the client and releases the required data to the client. The publication explained above also describes a method for recording a date and time for starting release of the information and a date and time for ending release of the information, and only releasing the information within the time period designated by those starting and ending dates and times.

In view of the above, it will be apparent to those skilled in the art from this disclosure that there exists a need for an improved program distribution system. This invention addresses this need in the art as well as other needs, which will become apparent to those skilled in the art from this disclosure.

### SUMMARY OF THE INVENTION

It has been discovered that, in the conventional program distribution system, when a new program or upgrade information for a program already in use is released to a plurality of clients at a prescribed date and time, the circuits become congested. More specifically, numerous clients access the server of the distributor at once through the internet immediately after release of the program begins. Furthermore, there is also a problem in that the version of the program held by each of the clients sometimes varies. When different versions are used, the clients cannot exchange information. This situation causes the clients on the same network to be temporary unable to share data. This is a major problem from the standpoint of operating the system.

One object of the present invention is to provide a program distribution system that can solve the above problems by achieving a situation in which all member clients can share the latest version of the program at all times without the occurrence of congested circuits.

In order to achieve the aforementioned object, the program distribution system for distributing a program to a client is provided that comprises a program distributing device and a client terminal device. The program distributing device includes a program subdividing section and a program distributing section. The program subdividing section is configured to subdivide the program into a plurality of program blocks with each having a predetermined size. The program distributing section includes a program block storing portion, a client authenticating portion, and a program block distributing portion. The program block storing portion is configured to store the program blocks subdivided in the program subdividing section. The client authenticating portion is configured to authenticate the client to whom the program blocks will be distributed. The program block distributing portion is configured to distribute the program blocks to the client. The client terminal device is utilized by the client for receiving the program blocks from the program distributing device. The client terminal device further includes a program block storing portion, restoration schedule setting portion and a restored program storing portion. The program block storing portion is configured to store the program blocks distributed from the program distributing device. The restoration schedule setting portion is configured to set a scheduled date and time for restoration of the program from the program blocks. The restored program storing portion is configured to store the program restored from the program blocks.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a system diagram illustrating a flow of a program distribution process executed by a program distribution system in accordance with one embodiment of the present invention;

FIG. 2 is a system diagram illustrating a flow of operations executed by the program distribution system in accordance with the one embodiment of the present invention at a point in time when a program is released; and

FIG. 3 is a schematic diagram of networks in which the program distribution operations are executed by the program distribution system in accordance with the one embodiment of the present invention.

DETAILED DESCRIPTION OF THE PREFERRED EMBODIMENTS

Selected embodiment of the present invention will now be explained with reference to the drawings. It will be apparent to those skilled in the art from this disclosure that the following descriptions of the embodiment of the present invention are provided for illustration only and not for the purpose of limiting the invention as defined by the appended claims and their equivalents.

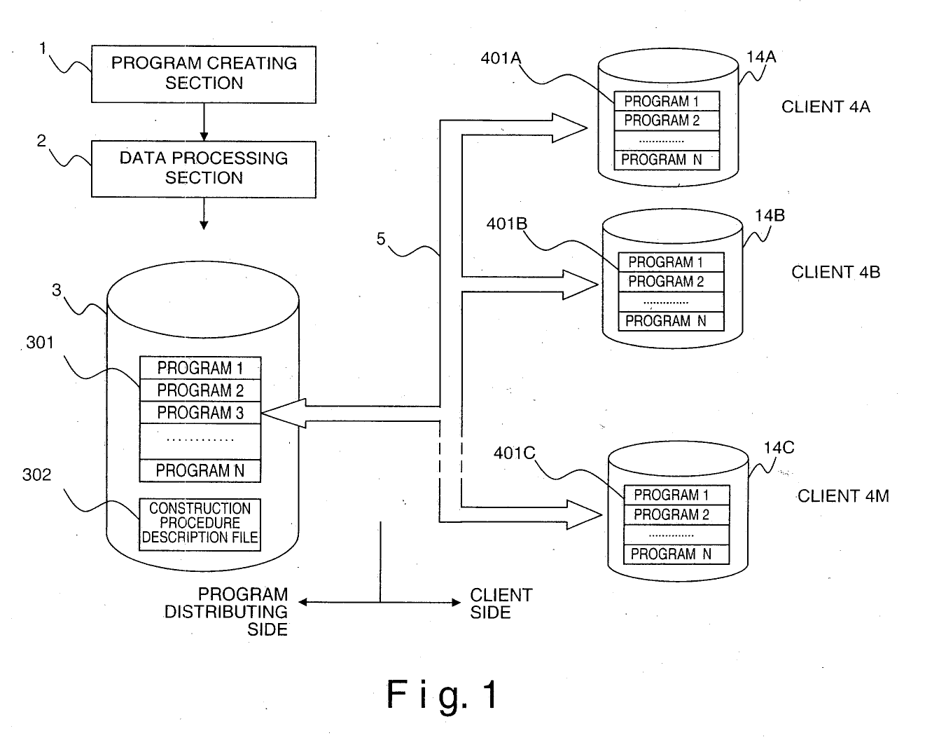

Referring initially to FIG. 1, a block diagram showing a program distribution process executed by a program distribution system is illustrated in accordance with one embodiment of the present invention. As shown in FIG. 1, the program distribution system in accordance with the one embodiment of the present invention basically comprises a program creating section 1, a data processing section 2 and a server 3 or a program distributing section. The program creating section 1 serves as a program controlling section of the present invention. The data processing section 2 serves as a program subdividing section of the present invention. The server 3 serves as a program distributing section of the present invention. The data processing section 2 and the server 3 together serve as a program distributing device. The program creating section 1 is configured and arranged to create a program and send the program to the data processing section 2. In the data processing section 2, the created program is compressed if necessary and subdivided into a plurality of program blocks (N blocks) with each having a predetermined length or size. The predetermined sizes of the program blocks are preferably equal to each other. Alternatively, the predetermined sizes of the program blocks can be varied as long as the predetermined sizes are arranged to carry out the present invention. The N blocks of the program blocks are stored in a program block storing portion such as memory 301 of the server 3 as Programs 1 to N. As the program blocks are stored in the memory 301, processing is executed to add the program title and a block number to each of the program blocks. If necessary, a preamble, a postamble, and other signals used for synchronization are added to each of the plurality of program blocks. More specifically, each of the program blocks is constructed as a new file so as to have the appearance of a subprogram. As seen in FIG. 1, each of the program blocks is stored and distributed as a unitary entity to a plurality of client terminal devices 14A, 14B, . . . , 14M that are utilized by a plurality of contracting clients 4A, 4B, . . . , 4M, respectively. The server 3 preferably includes a construction procedure description file 302 or a restoration program storing portion that contains a restoration program. The restoration program is used for restoring the program subdivided into the program blocks to its original form. The restoration program is preferably created in the server 3 and stored in the construction procedure description file 302 of the server 3.

It will be apparent to those skilled in the art from this disclosure that the server 3 can be arranged to perform the data compression and subdivision, which are executed by the data processing section 2 in this embodiment. Moreover, the creation of the program (program creating section 1), compressing the data and subdividing the program (data processing section 2), and distributing the program to the plurality of clients (server 3) are preferably executed by a program creator. Alternatively, the program creator can be arranged to perform only the creation of the program and the data processing, i.e., the compression and subdivision, while management of the server 3 and distribution of the program are performed by a distributor. In the latter case, transmission of the program from the program creator (program creating section 1 and data processing section 2) to the distributor (server 3) can be accomplished using a recording medium or through a communication route, such as a circuit forming a network. In either case, the program creating section 1, the data processing section 2 and the server 3 are configured and arranged to be handled by a program distributing side, i.e. the distributor and/or the program creator.

As seen in FIG. 1, the server 3 is installed on the program distributing side. The server 3, which serves as the program distributing section, includes a program block storing portion, a client authenticating portion, a program block distributing portion and a restoration program storing portion. The program block storing portion is configured to store the program blocks subdivided in the program subdividing section. The client authenticating portion is configured to authenticate the clients 4A-4M to whom the program blocks will be distributed. The program block distributing portion is configured to distribute the program blocks to the client terminal devices 14A-14M of the clients 4A-4M. The restoration program is configured to restore the program from the program blocks, and is sent to the client terminal devices 14A-14M of the clients 4A-4M.

The program blocks obtained from subdividing the program in the data processing section 2 are stored in the memory 301 of the server 3 as Programs 1 to N. The program blocks stored in the server 3 are distributed automatically to the client terminal devices 14A-14M through a circuit 5, e.g. network or the like, as appropriate in view of the congestion of the circuit 5. In other words, the server 3 is configured to distribute the program blocks to the client terminal devices 14A-14M in a time-divided manner such that separate distributions of a prescribed number of the program blocks are executed with a prescribed time delay between the separate distributions. The program blocks distributed from the server 3 are stored in memories 401A-401M of the client terminal devices 14A-14M, respectively, as a group of program blocks. The distribution operation described here takes place between the program distributing side (i.e., server 3) and the client side (i.e., the clients 4A-4M) after each of the contracting clients 4A-4M has been authenticated in a client authenticating portion of the server 3 by checking the client's identification number or the like. The program blocks comprising the program are stored sequentially in the memories 401A-401M of the client terminal devices 14A-14M in a state in which they were delivered. The distribution of the program blocks is completed before a scheduled time for release and restoration of the program.

At this stage, the subdivided program has merely been recorded and stored sequentially in the respective memories 401A-401M of the client terminal devices 14A-14M. The program cannot be opened by the clients 4A-4M until the scheduled time for restoration designated in advance by the program distributing side.

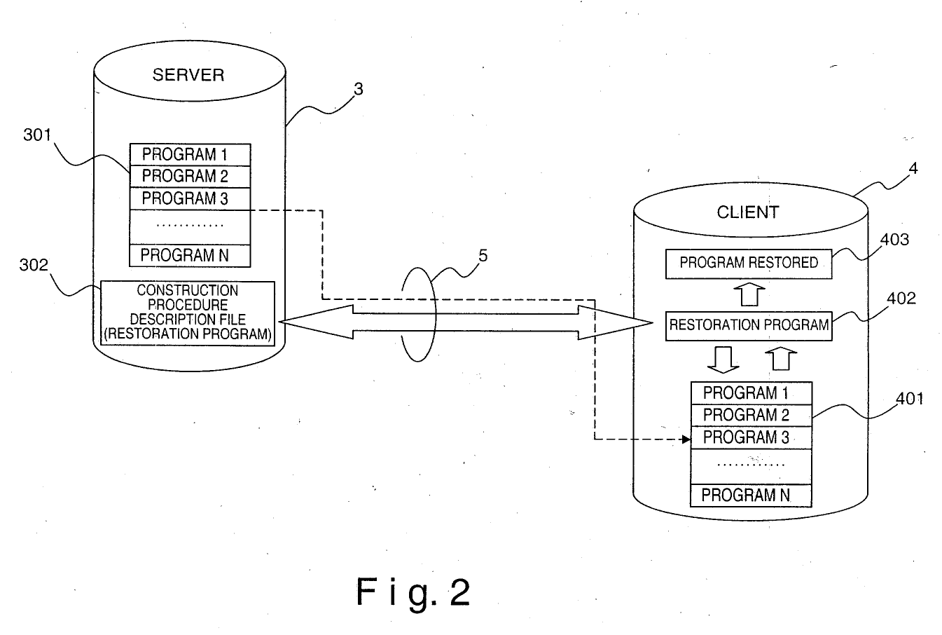

FIG. 2 explains the process of opening the program that has been delivered to a client terminal device 14 of a client as the program blocks. As explained above, the program blocks (Programs 1 to N) stored in the memory 301 of the server 3 are distributed to the client terminal device 14 before the scheduled time for restoration preset for the program is reached through the circuit 5 in a sporadic manner whenever the circuit 5 is less crowded as shown with a broken-line arrow of the circuit 5 in FIG. 2. Thus, all of the program blocks required to restore the program to obtain a restored program 403 is stored in a memory 401 of the client terminal device 14 in advance. The restored program is preferably stored in the memory 401 of the client terminal device 14.

Each of the client terminal devices 14A-14M is utilized by a client 4A-4M for receiving the program blocks from the program distributing device or server 3. Each of the client terminal devices 14A-14M includes a program block storing portion, restoration schedule setting portion, a restored program storing portion and an information exchanging section. The program block storing portion is configured to store the program blocks distributed from the program distributing device or server 3. The restoration schedule setting portion is configured to set a scheduled date and time for restoration of the program from the program blocks. The restored program storing portion is configured to store the program restored from the program blocks. The information exchanging section is configured to exchange information with the program distributing device, i.e., the server 3, to establish the restoration program in the client terminal devices 14A-14M.

The processing executed in order to restore the subdivided program as the program blocks stored in the client terminal device 14 into its original form such that it can be read by the client terminal device 14 will now be explained. As explained above, all of the program blocks (Programs 1 to N) required to restore the restored program 403 are delivered to the client terminal device 14 in advance. When the preset scheduled time for restoration has been reached and the client 4 powers on the client terminal device 14 such that the client terminal device 14 is in an operating state, the client terminal device 14 is configured and arranged to automatically request the delivery of the restoration program that is stored in the construction procedure description file 302 stored in the server 3. As explained above, the restoration program is used for restoring the program subdivided into the program blocks (Programs 1 to N) to its original form. As a result, the client terminal device 14 of the client 4 is configured to automatically reconstruct and restore the program as shown with a bidirectional arrow of the circuit 5 in FIG. 2. The restoration program stored in the construction procedure description file 302 is arranged to be at most several tens of kilobytes in size. Accordingly, in the program distribution system of the present invention, the program is reconstructed and restored from the program blocks that have already been stored in the client terminal device 14 in advance. Consequently, the actual distribution of the program does not place a heavy load on the circuit 5. Regarding the communication between the server 3 and the client terminal device 14 of the client 4 at this stage in the process, competition with other clients for use of the circuit 5 can be avoided by controlling the use of the circuit in a time-divided manner such that a time delay is provided in communications between the server 3 and a plurality of clients including the client 4.

The program distribution system in accordance with this embodiment of the present invention can also be utilized to upgrade or revise the program that has been already distributed to the client 4. More specifically, when the program is revised or updated, the program distributing side distributes a program block (or program blocks) that contains the updated or revised portion of the program to the client terminal device 14. Then, the program is restored such that the restored program includes the updated or revised portion of the program.

Accordingly, with the program distribution system in accordance with this embodiment, a large program is divided into smaller program blocks and delivered to a plurality of client terminal devices including the client terminal device 14 in advance. After a date and time for restoration of the program is reached, the restoration of the program or replacement of program blocks for an upgrade are executed automatically when the client 4 starts up his or her client terminal device 14. Consequently, impeded communication caused by concentrated communication through the circuit 5 by the clients does not occur, and thus, the client 4 does not have to tolerate long waiting times to install the program. Furthermore, the client 4 can always be kept in a state where he or she can use the latest version of the program without performing special operations for installing or upgrading the program.

Moreover, with the program distribution system of the present invention, the program can be partially revised or upgraded from the server 3 on a regular basis after the program has been restored by replacing certain program blocks with program blocks containing the revised or upgraded portions. In other words, the revision or upgrading can be accomplished on a program block basis. As a result, the clients 4 can use the latest version of the program at all times without downloading a program or performing other processing for installing the upgrade version. Accordingly, situations in which a plurality of clients cannot exchange data due to differences of versions of the program can be avoided.

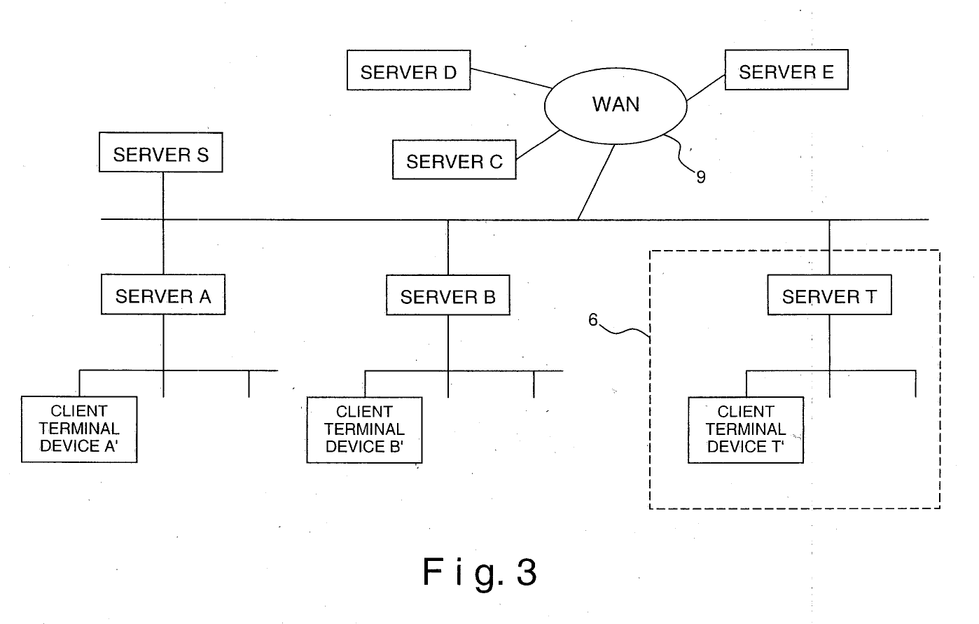

FIG. 3 shows an example of a network system for applying the program distribution system in accordance with the present invention. As explained below, this network system of FIG. 3 can be configured into two different network configuration to carry out the present invention, in a first configuration.

As seen in FIG. 3, the network is constituted through a circuit 5 that is connected to servers T, S, A and B, and WAN 9. Each of the servers A and B is further connected to a plurality of client terminal devices, only two of which are shown in FIG. 3, i.e., client terminal devices A′ and B′, respectively. The server T is connected to a client terminal device T. The server T and the client terminal device T′ constitute a sub network 6. The WAN 9 is further connected to a plurality of servers C, D and E, each of which is connected to a plurality of client terminal devices (not shown). Of course, it will be apparent to those skilled in the art from this disclosure that the specific configuration of the network can vary depending upon various factors and conditions. As explained below, this network system of FIG. 3 can be configured into tow different network configurations to carry out the present invention. In a first configuration, the sub network 6, the server T and the client terminal device T′ constitute a first network, a first server and a first client terminal device, respectively. The server S constitutes a second server and the servers A-E constitute third servers. The server S and the servers A-E form a second network.

In the network shown in FIG. 3, a program is developed, created, checked, revised and upgraded in the sub network 6. More specifically, the sub network 6 is arranged to form a mock network having a server (server T) and a client terminal device (client terminal device T). After the operation of the program is checked, the program is subdivided into program blocks of a prescribed length in the sub network 6. Then the program blocks are delivered to the server S and the program blocks are temporarily stored in a memory of the server S. The server T preferably includes a program transmitting section that is configured to transmit the program blocks automatically through the circuit 5. Alternatively, the delivery of the program blocks from the server T to the server S can be accomplished by sending the program blocks manually using a disc, tape, or other recording medium after the program operation check has been completed in the sub network 6. The server S is a distributor or, in the case of an intranet inside a specific group, a program supply source. In the network shown in FIG. 3, the system management related to distributing the program blocks is preferably handled by the server S.

As seen in FIG. 3, the server S is connected to the servers A and B through the circuit 5, and further connected to the servers C, D and E through the WAN 9. The server S is configured and arranged to distribute the program blocks sent from the server T to the servers A and B whenever appropriate in view of the congestion of the circuit 5. The servers A and B are configured to distribute the program blocks to the client terminal devices A′ and B′. Moreover, the server S is configured and arranged to distribute the program blocks to the servers C, D and E connected to the circuit 5 through the WAN 9. Each of the servers C, D and E is connected to a plurality of client terminal devises to distribute the program blocks to the plurality of clients. The program blocks distributed to each of the client terminal devices are stored in a memory of the client terminal device until a scheduled data and time for restoration of the program. After the schedule date and time for restoration, the client terminal device is configured to obtain a restoration program for restoring the program from the program blocks. Of course, it will be apparent to those skilled in the art from this disclosure that the restoration program can be arranged to be stored in any of the servers T, S, and A-E depending on the configuration of the network and other circumstances. Thus, the program can be distributed in the network shown in FIG. 3 to the clients without causing a congestion of the network.

Alternatively, a second configuration of the network system shown in FIG. 3 can be applied to the network system with relatively small scale of network. In the relatively small scale of network, the server T can be arranged to distribute the program blocks directly to the plurality of servers A-E and/or client terminal devices. In this second configuration, the sub network 6, the server T and the client terminal device T′ constitute a first network, a first server and a first client terminal device. The servers A-E preferably constitute second servers that form a second network.

Accordingly, with the program distribution system of the present invention, when a large program is distributed across a large network having many member terminals, the program can be distributed without impeding the clients' use of the network because the program is subdivided into program blocks and delivered in a fragmented form. Before the scheduled time for releasing the program, the program distribution system authenticates each client. Then, the program is distributed to a client terminal device of the client by subdividing the program into program block units and delivering the program block units at appropriate times in view of the congestion of the network. After the scheduled time for release and restoration, when the client terminal device is put into an operating state, the client terminal device automatically requests delivery of a construction procedure description file (restoration program) and construct and restore the program form the program blocks by using the construction procedure description file (restoration program). With the present invention, the load on the network and other circuits is reduced when the program is distributed to a plurality of clients. Moreover, all member clients can freely use the latest program at all times without being requested to perform special processing, such as downloading. Consequently, the clients can share information at all times and an efficient system can be achieved.

The servers 3, T, S and A-E and client terminal devices 4A-4M, A′ and B′ are preferably computers with programs for carrying out the present invention. Therefore, the servers 3, T, S and A-E and client terminal devices 4A-4M, A′ and B′ preferably include other conventional components such as an input interface circuit, an output interface circuit, and storage devices such as a ROM (Read Only Memory) device and a RAM (Random Access Memory) device. It will be apparent to those skilled in the art from this disclosure that the precise structure and configuration for the servers 3, T, S and A-E and client terminal devices 4A-4M, A′ and B′ can be any combination of hardware and software that will carry out the functions of the present invention. In other words, “means plus function” clauses as utilized in the specification and claims should include any structure or hardware and/or algorithm or software that can be utilized to carry out the function of the “means plus function” clause.

Moreover, a precise use or overall function of the client terminal devices 4A-4M, A′ and B′ can vary as long as the client terminal devices 4A-4M, A′ and B′ are configured and arranged to exchange data with the servers 3, T, S and A-E through a network. It will be apparent to those skilled in the art from this disclosure that the client terminal devices 4A-4M, A′ and B′ can be arranged such that these client terminal devices 4A-4M, A′ and B′ are mobile devices or computers with programs for carrying out the present invention. For example, the client terminal devices 4A-4M, A′ and B′ can be arranged as mobile terminal computers equipped on vehicles or a part of navigation systems equipped on the vehicles.

As used herein, the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2002-241687. The entire disclosure of Japanese Patent Application No. 2002-241687 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A program distribution system for distributing a program to a client comprising:
a program distributing device including
a program subdividing section configured to subdivide the program into a plurality of program blocks with each having a predetermined size, and
a program distributing section including
a program block storing portion configured to store the program blocks subdivided in the program subdividing section,
a client authenticating portion configured to authenticate the client to whom the program blocks will be distributed, and
a program block distributing portion configured to distribute the program blocks to the client;
and
a client terminal device utilized by the client for receiving the program blocks from the program distributing device including
a program block storing portion configured to store the program blocks distributed from the program distributing device,
a restoration schedule setting portion configured to set a scheduled date and time for restoration of the program from the program blocks, and
a restored program storing portion configured to store the program restored from the program blocks.

2. The program distribution system as recited in claim 1 wherein
the program distributing section further includes a restoration program storing portion configured to store a restoration program for restoring the program from the program blocks, and
the client terminal device further includes an information exchanging section being configured to exchange information with the program distributing device to establish the restoration program.

3. A method for distributing a program to a plurality of clients through a server such that the clients can open the program after a scheduled date and time for releasing the program, comprising:
subdividing the program into a plurality of program blocks with each having a predetermined size;
storing the program blocks in the server connected to a plurality of client terminal devices;
authenticating each of the clients through each of the client terminal devices;
distributing the program blocks to each of the client terminal devices; and
storing the program blocks in memory of each of the client terminal devices such that the program can be restored from the program blocks after the scheduled date and time for releasing the program has been reached.

4. The method for distributing the program as recited in claim 3, further comprising
automatically distributing a restoration program for restoring the program stored in a construction procedure description file of the server to each of the client terminal devices when each of the client terminal devices is powered on and put into an operating state after the scheduled date and time for releasing the program has been reached, and
reconstructing and restoring the program from the program blocks in each of the client terminal devices using the restoration program received from the server.

5. The method for distributing the program as recited in claim 3, further comprising
distributing at least one program block containing an updated portion of the program to each of the client terminal devices to revise a corresponding portion of the program.

6. The method for distributing the program as recited in claim 3, wherein
the distributing of the program blocks from the server to the plurality of client terminal devices is performed in a time-divided manner such that time differences exist among distributions of the program blocks from the server to the client terminal devices.

7. A program distribution system comprising:
a first network including a first server and a first client terminal device connected to the first server; and
a second network including a plurality of second servers connected to the first network through a data circuit, each of the second servers being connected to a plurality of second client terminal devices,
the first network further including
a program creating section being configured to create a program, revise the program and check an operation of the program,
a program subdividing section being configured to subdivide the program into a plurality of program blocks with each having a predetermined size,
a program distributing section being configured to distribute the program blocks to the second servers of the second network, and
a client authenticating section being configured to authenticate a client to which the program blocks will be distributed,
each of the second client terminal devices including
a program block storing section being configured to store the program blocks distributed from a corresponding one of the second servers,
a restoration schedule setting section being configured to set date and time for restoration of the program from the program blocks,
an information exchanging section being configured to exchange information with the corresponding one of the second servers to establish a restoration program for restoring the program from the program blocks, and
a restored program storing section being configured to store the program restored from the program blocks.

8. A program distribution system comprising:
a first network including a first server and a first client terminal device connected to the first server;
a second network including a second server connected to the first network and a plurality of third servers connected to the first network and the second server through a data circuit, each of the third servers having a plurality of third client terminal devices connected thereto,
the first network further including
a program creating section being configured to create a program, revise the program, and check an operation of the program,
a program subdividing section being configured to subdivide the program into a plurality of program blocks with each having a predetermined size, and
a program transmitting section being configured to transmit the program blocks to the second server, and
the second server including
a program block storing section being configured to store the program blocks, and
a program distributing section being configured to distribute the program blocks to the third servers, and
each of the third servers including
a client authenticating section being configured to authenticate a client to which the program blocks will be distributed,
a program block storing section being configured to store the program blocks, and
a restoration program storing section being configured to store the restoration program, and
each of the third client terminal devices including
a program block storing section being configured to store the program blocks distributed from a corresponding one of the third servers,
a restoration schedule setting section being configured to set date and time for restoration of the program,
an information exchanging section being configured to exchange information with the corresponding one of the third servers to establish a restoration program for restoring the program from the program blocks, and
a restored program storing section being configured to store the program restored from the program blocks.

9. A program distribution apparatus comprising:
a program distribution server configured to distribute a program to at least one client terminal device including
a program subdividing section being configured to subdivide the program into a plurality of program blocks with each having a predetermined size,
a restoration program creating section being configured to create a restoration program for restoring the program from the program blocks, and
a program distributing section being configured to distribute the program blocks and the restoration program to the at least one client terminal device.

10. The program distribution apparatus as recited in claim 9, wherein
the program subdivision processing section is further configured to compress data of the program.

11. The program distribution apparatus as recited in claim 9, wherein
the program distributing section is further configured to distribute the program blocks in a time-divided manner such that separate distributions of a prescribed number of the program blocks are executed with a prescribed time delay between the separate distributions.

12. The program distribution apparatus as recited in claim 9, wherein
the restoration program includes information regarding scheduled restoration date when the program is restored from the program blocks.

13. A method for distributing a program through a program distribution server to at least one client terminal device, comprising:
subdividing the program into a plurality of program blocks with each having a predetermined size;
creating a restoration program for restoring the program from the program blocks; and
distributing the program blocks and the restoration program to the at least one client terminal device.

14. The method of distributing the program as recited in claim 13, wherein the subdividing the program includes compressing data of the program.

15. The method of distributing the program as recited in claim 13, wherein,
distributing the program blocks in a time-divided manner such that separate distributions of a prescribed number of the program blocks are executed with a prescribed time delay between the separate distributions.

16. The method of distributing the program as recited in claim 13, wherein
creating the restoration program to include information regarding scheduled restoration date when the program is restored from the program blocks.

17. A program distribution system for distributing a program to a client comprising:
program distributing means for
subdividing the program into a plurality of program blocks with each having a predetermined size,
storing the program blocks subdivided in the program subdividing section,
authenticating the client to whom the program blocks will be distributed, and
distributing the program blocks to the client; and
program receiving means for
receiving and storing the program blocks from the program distributing means,
setting a scheduled date and time for restoration of the program from the program blocks, and
storing the program restored from the program blocks.

18. A program distribution apparatus for distributing a program to at least one client terminal device comprising:
program subdividing means for subdividing the program into a plurality of program blocks with each having a predetermined size,
restoration program creating means for creating a restoration program to restore the program from the program blocks, and
program distributing means for distributing the program blocks and the restoration program to the at least one client terminal device.
